(19) United States
(12) Patent Application Publication
(10) Pub. No.: US 2008/0069370 A1
(43) Pub. Date: Mar. 20, 2008

(54) Apparatus and method for elevating sound quality and sound volume of GPS product by means of vehicle stereo

(75) Inventor: Chih-Ming Chang, Taipei Hsien (TW)

Correspondence Address: BRUCE H. TROXELL;SUITE 1404, 5205 LEESBURG PIKE, FALLS CHURCH, VA, 22041, US

(73) Assignee: WISTRON CORP.

(21) Appl. No.: 11/790,829

(22) Filed: Apr. 27, 2007

(30) Foreign Application Priority Data
Aug. 8, 2006 (TW) 095129007

(51) Int. Cl. H04B 1/00

(52) U.S. Cl. 381/86

(57) ABSTRACT

An apparatus and method for elevating sound quality and sound volume of a GPS product by means of a vehicle stereo allows a sound decoding IC of the GPS product to be electrically connected to not only a first speaker but also a first FM module to enable a second FM module of a vehicle sound module to receive sound signals output from the first FM module, and sound waned to output by the GPS product is output via a second speaker electrically connected with the vehicle stereo module so as to obtain the better sound quality and volume.

### BACKGROUND OF THE INVENTION

1. Field of the Invention

The present invention relates to a GPS (global positioning system) product, and more particularly to a method and apparatus for elevating sound quality and sound volume of a GPS product.

2. Description of Related Art

There are many portable GPS products with both satellite navigation and audio-visual entertainment functions in the market, it allows a user uses them to process navigation through an e-map shown on a displayer and view photographs stored in a memory card, process video-audio playing or audio playing.

There also are many patents disclose technologies on allowing a GPS module to be combined with a car stereo, for example, a satellite navigator disclosed in Taiwan Patent No. 1249,038 comprises a car computer coupled to a GPS module, a navigation and global information system, used for receiving position information and outputting a display information after being integrated with an e-map and navigation data, and an output/input device coupled to the car computer and having burglarproof and multi-media playing functions, in which the output/input device comprises a stereo mainframe used for providing the amplification and the processing functions of stereo signals and a main speaker coupled to the stereo mainframe and used for outputting sound. Taiwan Patent No. M253,165 discloses an integrative multimedia microcomputer device, it can respectively have wired connections with an external GPS module and a car stereo. Besides, Taiwan Patent No. 376,597 discloses a car stereo with a communication function, in which a AV terminal thereof can be allowed to connect externally with a liquid crystal display (LCD) used as a display of receiving/sending out a facsimile, e-mail and internet accessing or video conference, or a GPS.

For carrying conveniently, a smaller speaker is adopted for almost the portable electronic devices mentioned above so that the outputting sound quality and volume are limited.

Those disclosed in the patents mentioned above comprises a GPS module connected on wire to a car stereo. The GPS module has not a video-audio playing tool and is not the portable GPS product mentioned above; if it is separated from the car stereo, it is not provided with an audio-visual entertainment function.

### SUMMARY OF THE INVENTION

For improving sound quality and sound volume of a GPS product, the present invention is proposed.

The main object of the present invention is to provide an apparatus and method for elevating sound quality and sound volume of a GPS product by means of a vehicle stereo, allowing a general portable GPS product to be wirelessly connected to a vehicle stereo so as to output the better sound quality and volume.

Another object of the present invention is to provide an apparatus and method for elevating sound quality and sound volume of a GPS product by means of a vehicle stereo, enabling a general vehicle stereo to receive radio signals output from a GPS product conveniently so as to broadcast the sound output from the GPS product.

A method for elevating sound quality and sound volume of a GPS product by means of a vehicle stereo is used for elevating sound quality and sound volume of a GPS product, it comprises the following steps:

Transmitting sound signals to a first FM module of a GPS product;

Allowing the first FM module to output the sound signals wirelessly;

Allowing a second FM module of a vehicle stereo module to receive the sound signals wirelessly output from the first FM module; and

Allowing the vehicle stereo module to process the sound signals and then transmitting the processed sound signals to a second speaker connected electrically with the vehicle stereo module to obtain the better sound quality and volume by outputting sound from the second speaker.

The sound signals transmitted to the first FM module of the GPS product can be output via a sound decoding IC of the GPS product.

An image of a switch can be shown in a window picture on a displayer of the GPS product to allow a user to select transmitting the sound signals output from the sound decoding IC to a first speaker or the first FM module of the GPS product.

A central processing unit (CPU) can transmit a processed sound signals to the sound decoding IC to allow the sound decoding IC to output the sound signals.

The CPU can detect to obtain information stored in a memory card read by a memory card connector of the GPS product.

The sound signals output from the sound decoding IC can be transmitted to the first FM module or a first speaker of the GPS product through the choice of a switch of the GPS product.

An apparatus for elevating sound quality and sound volume of a GPS product by means of a vehicle stereo comprises a GPS product, a vehicle stereo module and a second speaker.

The GPS product comprises a CPU respectively electrically connected with a GPS module, memory, displayer and sound decoding IC. The GPS module is further electrically connected to an antenna, the sound decoding IC is further connected to a switch and the switch is further respectively electrically connected to a first speaker and a first FM module. The GPS module receives signals transmitted from positioning satellites and outputs satellite positioning information and navigation information through the antenna. The CPU detects to obtain video/audio information output from the GPS module and respectively transmits it to the displayer and the sound decoding IC after being processed. Image information is shown through the displayer. The memory stores programs needed to execute by the CPU and programs needed for an operation system of the GPS product.

The vehicle stereo module comprises a second FM module.

The second speaker is electrically connected to the vehicle stereo module.

Among these, the switch is used for providing a choice to transmit the sound signal to the first speaker and then outputting sound through the first speaker or transmitting the sound signal to the first FM module, then wirelessly transmitting it to the second FM module through the first FM module, transmitting it to the second speaker after it is processed by the sound stereo module and finally outputting sound via the second speaker so as to attain to the better sound quality and volume.

The CPU is electrically connected to a memory card connector. The memory card connector is used for connecting with a memory card to read information stored in the memory card or store information into the memory card.

The memory comprises a SDRAM and flash memory; the SDRAM is used for storing programs wanted to execute by the CPU and the flash memory is used for storing programs needed by an operation system of the GPS product. The vehicle can be a car, motorcycle or vessel.

### BRIEF DESCRIPTION OF THE DRAWINGS

The present invention can be more fully understood by reference to the following description and accompanying drawings, in which:

FIG. 1 is a block diagram of a functional circuit structure of an apparatus according to the present invention; and

FIG. 2 is a flow chart of a method according to the present invention.

### DETAILED DESCRIPTION OF THE PREFERRED EMBODIMENTS

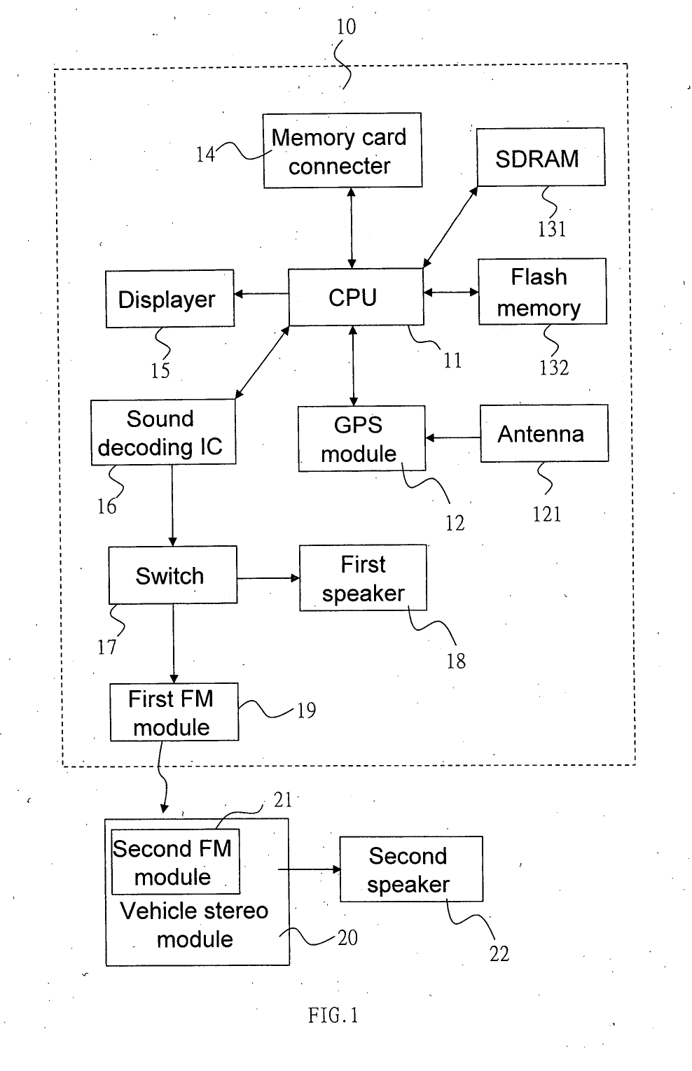

Please refer to FIG. 1. An apparatus for elevating sound quality and sound volume of a GPS product by means of a vehicle stereo is used for elevating sound quality and sound volume of a GPS product. An apparatus of a preferred embodiment according to the present invention comprises a portable GPS product 10 and a vehicle sound module 20. The GPS product 10 comprises a CPU 11 respectively electrically connected with a GPS module 12, SDRAM 131, flash memory 132, memory card connector 14, displayer 15 and sound decoding IC 16, in which the GPS module 12 is further electrically connected to an antenna 121 and the sound decoding IC 16 is further electrically connected to a switch 17. The switch 17 is further respectively electrically connected to a first speaker 18 and a first FM module 19. The vehicle stereo module 20 comprises a second FM module 21. The vehicle stereo module 20 is electrically connected with a second speaker 22. The vehicle according to the present invention can be a man-carrying means of transportation such as car, motorcycle or vessel. The sound decoding IC 16 is generally used for processing sound signals output from the CPU 11 to become the sound signals that the first speaker 18 can broadcast and the first FM module 19 can transmit wirelessly. The first FM module 19 generally comprises a circuit and antenna allowing the sound signals to be wirelessly output. The second FM module 21 generally comprises a circuit and antenna receiving the sound signals wirelessly.

The GPS module 12 generally receives signals transmitted from at least three positioning satellites through the antenna 121 and processes the satellite signals to output the satellite positioning information and the navigation information of a location of the GPS module. The memory card connector 14 can generally be connected with a memory card to read information stored in the memory card or store information into the memory card. The CPU 11 can respectively detect to obtain information output from the CPS module 12 and the memory card connector 14 and respectively transmit it to the displayer 15 and the sound decoding IC 16 after being processed. An e-map, GPS navigation information and image information stored in a memory card can be shown through the displayer 15. The CPU 11 can also be allowed to detect to obtain the satellite positioning information of a location of the GPS module 12 transmitted from the GPS module 12 and the information output from the memory card connector 14, and then output audio-visual data corresponding to the satellite positioning information stored in the memory. A user can choose transmitting the sound signals to the first speaker 18 through the switch 17 and outputting sound concerning CPS navigation and sound stored in the memory card via the first speaker 18 or transmitting the sound signals to the first FM module 19 and then transmitting wirelessly to the Second FM module 21 to be processed in the vehicle stereo module 20 to transmit to the second speaker 22 and output voice via the second speaker 22. The SDRAM 131 stores programs wanted to execute by the CPU 11 and the flash memory 132 stores programs needed by an operation system of the GPS product 10.

An apparatus of the present invention is characterized in that the sound decoding IC 16 is allowed to connect electrically to not only the first speaker 18 but also the first FM module 19. Being able to adjust the first FM module 19 to output a specific FM frequency and not interfering the second FM module 21 of the vehicle stereo module 20 to receive normally a frequency broadcasted by a FM radio station allow the second FM module 21 to receive the sound signals output from the first FM module 19. Furthermore, the sound wanted to output by the GPS product 10 is output via the second speaker 22 so as to obtain the better sound quality and volume.

The sound decoding IC 16 in an apparatus of the present invention can further be electrically connected to the switch 17. When the GPS product 10 wants to be output sound via the second speaker 22 in the vehicle, a user can then allow the sound output from the sound decoding IC 16 to be transmitted to the first FM module 19 to enable the first FM module 19 to output the sound signals wirelessly to the second FM module 21 of the vehicle stereo module 20 and further output the sound via the second speaker 22.

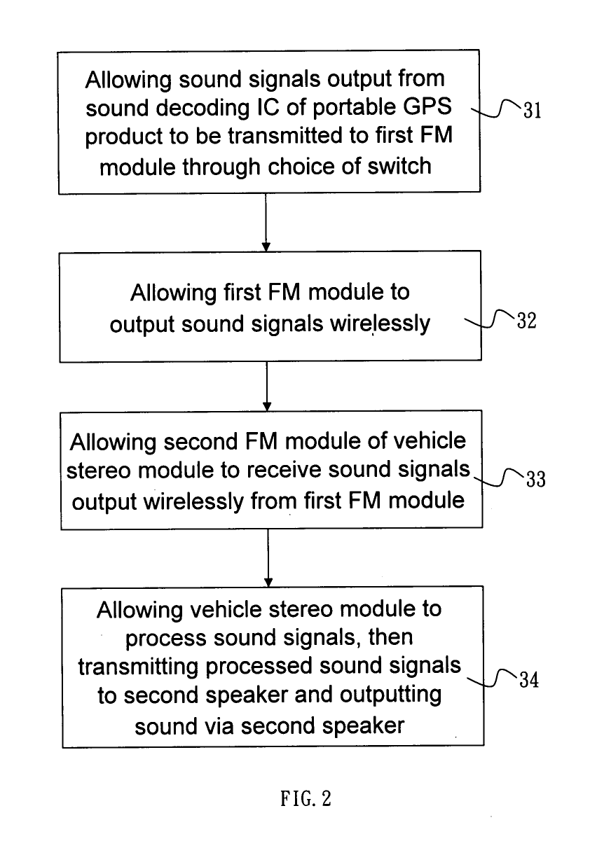

Please refer to FIGS. 1 and 2. A method for elevating sound quality and sound volume of a GPS product by means of a vehicle stereo according to the present invention is used for elevating sound quality and sound volume of the GPS product, a method of a preferred embodiment according to the present invention comprises the following steps:

Step 31: allowing sound signals output from a sound decoding IC 16 of a portable GPS product 10 to be transmitted to a first FM module 19 through a choice of a switch 17;

Step 32: allowing the first FM module 19 to output the sound signals wirelessly;

Step 33: allowing a second FM module 21 of a vehicle stereo module 20 to receive the sound signals wirelessly output from the first FM module 19; and

Step 34: allowing the vehicle stereo module 20 to process the sound signals and then transmit the processed sound signals to a second speaker 22, and outputting sound via the second speaker 22.

The method of the present invention allows a portable GPS product to be connected with a vehicle stereo module wirelessly conveniently. Utilizing a speaker in a vehicle to broadcast sound with better sound quality and volume enables a stereo module in the vehicle to broadcast sound output from the portable GPS product concurrently to allow the portable GPS product to have more practical value.

Furthermore, an image of a switch can be shown in a window picture on a displayer according to the present invention to provide a user a choice to transmit the sound signals mentioned above to the first speaker 18 or the first FM module 19.

The apparatus and the method for elevating sound quality and sound volume by means of a vehicle stereo mentioned above allows a general portable GPS product to be able to be connected with a vehicle stereo module wirelessly to output the better sound quality and volume, and enable a general vehicle stereo module to receive radio signals output form the GPS product conveniently to broadcast the sound output from the GPS product.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A method for elevating sound quality and sound volume of a GPS product by means of a vehicle stereo, used for elevating sound quality and sound volume of a GPS product, comprising the following steps:
transmitting sound signals to a first FM module of a GPS product;
allowing said first FM module to output said sound signals wirelessly;
allowing a second FM module of a vehicle stereo module to receive said sound signal output wirelessly from said first FM module; and
allowing said vehicle stereo module to process said sound signals, then transmitting said processed sound signals to a second speaker electrically connected with said vehicle stereo module and outputting sound through said second speaker.

2. The method according to claim 1, wherein said sound signal transmitted to said first FM module of said GPS module is output through a sound decoding IC of said GPS product.

3. The method according to claim 2, wherein a window picture on a displayer of said GPS product shows an image of a switch so as to allow a user to select transmitting said sound signals output from said sound decoding IC to a first speaker or said first FM module of said GPS product.

4. The method according to claim 2, wherein a central processing unit of said GPS product transmits said processed sound signals to said sound decoding IC to allow said sound decoding IC to output said sound signals.

5. The method according to claim 4, wherein said CPU detects to obtain information stored in a memory card read by a memory card connector of said GPS product.

6. The method according to claim 2, wherein said sound signal output from said sound decoding IC is transmitted to said first FM module or a first speaker of said GPS product through a choice of a switch of said GPS product.

7. An apparatus for taking a method for elevating sound quality and sound volume of a GPS product by means of a vehicle stereo of claim 6 into practice, comprising: a GPS product, comprising a CPU respectively electrically connected with a GPS module, memory, displayer and a sound decoding IC; said CPS module being further electrically connected to an antenna; said sound decoding IC being further electrically connected to a switch; said switch being further respectively electrically connected to a first speaker and a first FM module; said GPS module receiving signals transmitted from positioning satellites through said antenna and outputting satellite position information and navigation information; said CPU detecting to obtain audio-visual information output from said GPS module and respectively transmitting to said displayer and said sound decoding IC after being processed; said audio-visual information being shown through said displayer; said memory storing programs wanted to execute by said CPU and programs needed for an operation system of said CPU product;
a vehicle stereo module, comprising a second FM module; and
a second speaker, connected electrically with said stereo module;
wherein, said switch is used for selecting transmitting sound signals to said first speaker and sound is output via said first speaker, or transmitting said sound signal to said first FM module, transmitting said sound signal wirelessly to said second FM module through said first FM module and then transmitting said sound signals to said second speaker after being processed through said second speaker, and finally sound is output via said second speaker.

8. The apparatus according to claim 7, wherein said CPU is electrically connected to a memory card connector; said memory card connector is used for connecting with a memory card; whereby, audio-visual information stored in said memory card is read and information is stored in said memory card.

9. The apparatus according to claim 7, wherein said memory comprises a SDRAM and flash memory, said SDRAM is used for storing programs wanted to execute by said CPU; said flash memory is used for storing programs needed for an operating system of said GPS product.

10. The apparatus according claim 7, wherein said vehicle is car, motorcycle or vessel.
